(19) United States
(12) Patent Application Publication
(10) Pub. No.: US 2008/0268408 A1
(43) Pub. Date: Oct. 30, 2008

(54) METHOD FOR IMPROVING THE EMOTIONAL QUOTIENT IN INFANTS AND CHILDREN

(76) Inventor: Christine Zernzach, (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/923,706

(22) Filed: Oct. 25, 2007

Related U.S. Application Data
(63) Continuation of application No. 10/972,555, filed on Oct. 25, 2004, now abandoned.
(60) Provisional application No. 60/566,842, filed on Apr. 30, 2004.

(51) Int. Cl. G09B 19/00

(52) U.S. Cl. 434/236

(57) ABSTRACT

This invention is a method to teach emotional awareness to children. The method uses a video to increase the child's emotional quotient. The emotional quotient is a measure like intelligence quotient that measures sensitivity to emotions. Because the video uses images it can be used with pre-literate or even pre-language children. It can also be used as a tool for teachers, parents and therapists who are using a larger education system or the video can be used by the child as a primary educational tool.

### CROSS-REFERENCE TO RELATED APPLICATIONS

This application is a continuation of U.S. patent application Ser. No. 10/972,555, filed Oct. 25, 2004, which claims the benefit of Provisional Patent Application Ser. No. 60/566,842, filed Apr. 30, 2004 by the present inventor.

### FIELD OF INVENTION

This invention relates to the teaching of emotions. More specifically, this invention relates to the teaching of emotions to infants and children. Even more specifically, this invention relates to the teaching improvements in infants and children's emotional quotient. Most specifically, the invention relates to the teaching improvements in infants and children's emotional quotient using a VHS tape or DVD.

### BACKGROUND OF INVENTION

Many people, in many situations, have performed emotional education. Parents, teachers and therapists all educate people in emotions. To date, emotional education has been performed on a service model. This model has limitations.

The most expert emotional educators are therapists. A “therapist” may be a licensed counselor, social worker, psychologist, psychiatrist, early intervention educator or other specified behavioral/emotional counseling professional. Therapists are professionally trained to teach about emotions and emotion management. Therapists have developed a large variety of emotional teaching methods and emotional teaching theories. Therapists are the ideal example of service based emotional education. The limitation on this service by therapists is that the therapist must perform it personally. Since a limited number of therapists exist in any given area, the supply of emotional education services is limited. This limits the access that the public has to professional emotional education services. This problem is compounded by the cost of therapist services. This cost further limits the access of people to emotional services, especially the poor and the uninsured. Also, while therapists are trained in teaching emotions, they are focused on fixing problems, rather than preventing problems from developing. In practice, most therapists only see a patient once a problem has arisen.

The most common emotional educators are parents. Like therapists, parents must perform their services personally. Unlike therapists, the cost of parental emotional education is essentially free. But even parents have limited time. With the prevalence of families either headed by single working parents or by two working parents, parents are not acting as full time emotional educators. Also parents have no training in emotional education. The assumption in this society is that because everyone had parents, everyone can be a parent. Practice has not reflected this theory. Many parents do not know how to teach emotions. Many parents were raised by people who also did not know how to teach emotions. Thus, most parents both lack the skills and lack role models to acquire the skills from. Furthermore, parents who look for role models will find resources aimed at academics and adults, but very little that is practical advice on the day-to-day methods of teaching emotions to children, especially young children. Thus, regardless of the good intentions of most parents, any effort to acquire the tools to teach emotional education will likely be foiled. Thus parents are limited in their ability to be emotional educators.

Teachers may also serve as emotional educators. While mainstream elementary school teachers devote large amounts of time to the education of groups of children, they do not have the resources to devote large dedicated amounts of time to specific children. The nature of modern education is that it is group education. Thus while teachers may teach emotional skills, they are not able to give the kind of personalized attention that parents and therapists can give. Teachers are not expected to teach about emotion management before problems begin. They are primarily trained in the teaching of facts and academic learning skills. The role of emotional educator is a secondary role for teachers where training is not standardized. Thus regular classroom teachers are limited in their ability to be emotional educators.

Previous inventions have been aimed at adults, require verbal communication or require interaction by the user.

In U.S. Pat. No. 6,497,577, by Kanter, the invention is based upon asking questions. This requires that the users of the invention be old enough to have acquired language skills. Additionally, the invention requires the use of a computer, which means that the users to operate the invention must obtain a certain level of literacy. The invention focuses on the negative emotions. The invention also associates all negative emotions with either the “flight” or “fight” responses. Finally, the invention uses anecdotes from the user to help identify negative emotions. The invention then uses community or spiritual healing to help the user copy with his negative emotions.

U.S. Pat. No. 6,715,762, by Simmons, is based upon an interactive game. The game uses game pieces, such as playing cards. The invention requires two people and is based on communication, thus requiring a level of language skills and literacy.

U.S. Pat. No. 6,394,453, by Siemers, uses either a board game or a database to create a scoring system for emotions. The invention provides the user with hypothetical human interactions and possible responses. The user also has the opportunity to invent their own responses. The goal is teach users to codify human behavior. It requires communication and is aimed at more than just the basic emotions. It also requires both literacy and language skills that are not found in children.

U.S. Pat. No. 5,676,551, by Knight, is a simulation of human interactions. It requires a computer or interactive television. The user changes the emotions of the computer personalities and then allows different personalities to interact.

U.S. Pat. No. 4,931,934, by Snyder, is a method of measuring human emotional responses. It does not teach knowledge or experience with human emotions.

There are a number of commercial products that teach emotional intelligence, but all of these products are targeted at adults.

One example is Emotional Intelligence in the Workplace by Corporate Perspectives, Inc. The purpose of the video is to train employees to have stronger client relationships using emotional intelligence concepts.

Another example is the Social and Emotional Learning (SEL) Video Series by CASEL. The purpose of videos is to provide SEL practitioners with concrete guidance and tools for effectively implementing SEL practices. The videos are geared towards educators and administrators

Another example is the Emotional Intelligence Video Program by CMR Learning. The purpose of the video is to teach how Emotional Intelligence competencies can be combined with other knowledge and technical abilities to increase one's overall effectiveness on the job. It is aimed at adults in the work environment.

Another example is Emotional Intelligence produced by National Professional Resources, Inc. The video features a live lecture by Daniel Goleman who explains why emotion is another measure of intelligence and provides tools for leaders to improve their emotional reactions. The targeted audience is senior management

Another example is Developing an Emotionally Intelligent Team produced by Training Point. The purpose of the video is to develop high performance teams that have exceptional inter-personal skills. The targeted audience is adults in work environment.

Yet another example is Brains: Harnessing the Power of Emotional Intelligence by Talent Smart Service. The video is a training video designed to teach emotional intelligence in a fun way to help clients develop human capital. The targeted audience is businesses and employees.

One commercial emotional education product for children is The Magic Boat Palooka by the Children's Emotional Literacy Project. It is part of the Enchante Emotional Literacy Videos. Its purpose is to help older children identify core emotions and understand how to transform and express feelings. It is targeted at children ages 8-12 years old.

### SUMMARY OF THE INVENTION

The present invention has advantages that the prior art does not. The present invention also discloses elements and features not found in the prior art.

The goal of this invention is to be a technology that can magnify the emotional education services performed by therapists, parents and teachers. The specific quality of the child that is being educated is the child's emotional quotient (EQ). The EQ is the emotional equivalent of the IQ. It is a measure of the child's ability to analyze emotional content in interactions with other people. This ability translates into success in working and function with other people. This ability also translates into greater emotional stability and greater happiness for the child. Unlike IQ that is felt to be fixed by heredity, EQ can be learned and unlearned. The purpose of this invention is to accelerate the learning of EQ. The invention is not dependent on the use of words, writing or any language. Thus the invention can be used with pre-literate, pre-speaking and disable children.

The invention is a video performance that is prepared by a professional for an adult to show a child at a latter time. The professional selects the emotions, images and order for the video performance. This video is then given to another adult for use with children that that adult is trying to educate about emotions. It can be shown to the child either under the supervision of an emotional educator, such as a therapist, parent or teacher, or shown to the child without adult supervision. The invention is an automated teaching method that can teach without requiring a second person. The video can be stored on a VHS tape, DVD or in a MPEG or other electronic format. The video can be shown on a television or a computer or any other display. The video could be broadcasted over radio frequencies or other broadcast media, or through a standard cable television arrangement. The preferred embodiment is a DVD that can be stored and re-shown to the child.

The problem with learning emotions is that the appearance of emotions is not consistent or predictable as practiced by adults. Some people are more emotive than others. Some people express more emotion in their body language or facial features than others. Some people react to different situations differently. This variety is confusing to infants and small children who are trying to learn both their own emotions and the emotions of others. Underlying the variety of emotions and emotional signals are six primary emotions. Most adults have learned what these six emotions are and how to apply them in real situations. The six primary emotions are happy, sad, love, angry, surprised and scared.

Just as simplifying and exaggerating speech teaches language, simplifying and exaggerating facial expressions can teach emotions. This invention is a system by which children are taught emotions by showing them simplified and exaggerated facial expressions. All emotional educators use simplified and exaggerated facial expression to teach emotions, but the lesson can only proceed if the emotional educator is devoting personal attention to the child. This creates an artificial limitation on the amount of emotional education the child can receive. Cartoons and other entertainment media have used exaggerated facial expressions for entertainment, but not as part of a specifically emotional education program. This method combines replayable videos with a specific and conscious program of emotional education.

The simplification and exaggeration of facial expressions also furthers the other goal of the invention. By making the six primary emotions easy to identify, the child can be taught how to respond to each of these primary emotions. Mere emotional identification does not enhance the EQ of the child. The child must learn to use emotions to interact with others. To do this, the child must learn the appropriate way to respond to emotions that the child has identified. It is in this area that most adults lack skills. While most adults can teach a child the primary emotions, most adults have not been taught how to respond to emotions appropriately themselves. Thus, the video allows the emotional educator to use the video as a reference for both the educator and the child.

But simply showing a child simplified and exaggerated facial expression is not enough to teach emotions, emotional recognition and the appropriate response to emotions to the child. Each of the primary emotions must be identified with an objective marker so that the child can know which emotion it is. This is also important because emotional education can begin before a child is literate or has acquired any language skills. Thus the marker must be more than just a label in English. Each of the six primary emotions must be assigned a color, icon, type of music, character, type of animal, person miming the emotion or appropriately decorated clown, or other marker, and each time that emotion appears in the marker must also appear. Thus, by way of example and not meant to limit the invention in any way, the child will learn that sad is blue and every time the child sees blue in the video, the child knows that the emotion is sad. Consequently, the child can assess the facial expressions of the characters in the video, hear the music, see the marker, such as the color blue, and determine the emotional content of the situation or facial expression. Natural phenomenon such as weather, thunder or earthquakes can also be used as markers.

The video will progress through a set of scenarios were things happen that evoke an emotional response. The marker then appears with each emotional response, allowing the child to link the emotion to a certain facial expression. The video can further expound on the emotional content of the scenarios by quizzing the child. The video can ask the child to identify the emotion, identify the marker or identify the proper response to the emotion.

The goal of the video is not just to teach emotional identification, but also to teach the child to manage their own emotions. Thus, each scenario will carry a lesson on how to respond to that emotion. Therefore, by watching the video, the child will learn what the primary emotions are, how to identify them in others and how to respond to each emotion properly.

The video can be used as part of a larger program under the supervision of an emotional educator, or shown to the child by itself. The ability of the invention to teach without a second person is what makes it automated. The emotional educator can talk to the child about certain emotions or certain situations and then show the appropriate portion of the video to give the child a coded and simplified version of the topic, thus reinforcing the lesson taught by the emotional educator. Alternatively, the child can be shown the video without instruction and learn from the scenarios shown in the video. This will allow continued emotional education when there is no emotional educator available to teach the child. It will also reinforce any emotional lesson that the child has been taught in the past.

The video does not need to be used in isolation. The video can have section in which the child is asked to draw certain emotions, draw the marker for certain emotions or draw the response to the emotions. These lessons are further reinforced by regular music and song. The child is encouraged to sing with the melody or jingle to further ingrain the lesson about emotions and their appropriate responses. When the video is used in conjunction with the supervision of an emotional educator, the child can also use food art and clay modeling to further model emotions and their appropriate responses.

### BRIEF DESCRIPTION OF THE DRAWINGS

The accompanying drawings, which are incorporated in and form part of the specification, illustrate the embodiments of the present invention and, together with the description, serve to explain the principles of the invention.

FIG. 1 shows the progression from each icon from the preferred embodiment for each primary emotion, in the order of presentation in the preferred embodiment.

FIG. 2 shows the progression of images and scenes in a sample segment for one primary emotion from the preferred embodiment.

FIG. 3 is a chart of the primary emotions, the corresponding color and corresponding character from the preferred embodiment.

FIG. 4 is an example introduction scene for a primary emotion, in this case “happy”, from the preferred embodiment.

### DETAILED DESCRIPTION

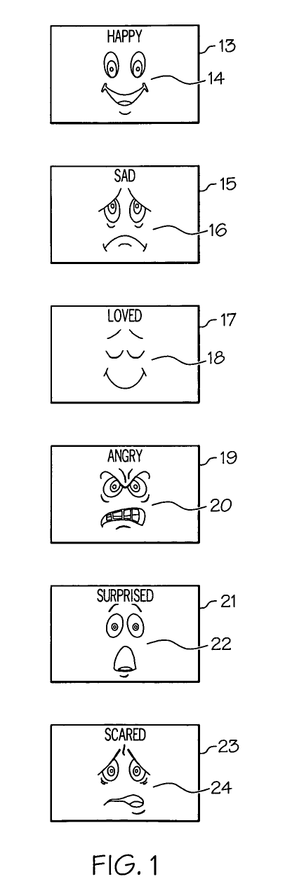

FIG. 1 is a flowchart of the progression from one icon for each primary emotion to the next primary emotion from the preferred embodiment. In this preferred embodiment, the primary emotions are revealed in a particular order. The order is happy 13, then sad 15, then loved 17, then angry 19, then surprised 21, and finally scared 23. Each primary emotion has an associated icon. The icon for happy 14 is a smiling mouth and two open eyes. The icon for sad 16 is an upturned mouth with two open eyes. The icon for loved 18 is a smiling mouth with closed eyes. The icon for angry 20 is an upturned mouth with two open eyes and eyebrows that point downward. The icon for surprised 22 is an open mouth, two open eyes and two eyebrows raised up. The icon for scared 24 is two open eyes, two eyebrows raised and a wavy line for the mouth.

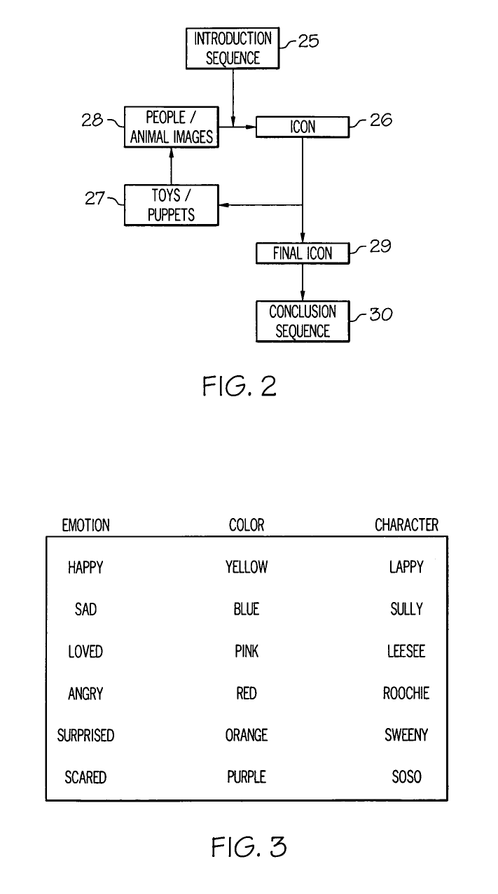

FIG. 2 is a flowchart of the progression of a segment of the video for one primary emotion from the preferred embodiment. The segment begins with an introduction sequence 25. The introduction sequence introduces the marker or markers for that emotion. The preferred embodiment uses a character, a color, a particular musical score, a song and an icon for each primary emotion. All these markers are introduced in the introduction sequence 25 so that the child knows that these markers are for that primary emotion. Each marker must be unique to one primary emotion, but one primary emotion can have more than one marker. The segment then enters a circular sequence where alternatively an icon scene 26, a toy/puppet scene 27 and a people/animal scene 28 is shown. While the preferred embodiment proceeds in this order, any order could be used. Furthermore, each scene is named by the dominant element, but other element can be used. The icon scene 26 can also contain people or puppets drawing the icon. The toy/puppet scene 27 can also include people playing with the toy or the puppet, and can include the icon in the background or on the people, toys or puppets. The people/animal scene 28 can include both the icon and toys or puppets. In any given scene, the dominant feature determines what kind of scene it is, not the other elements. After a number of completions of the sequence of scenes, the segment ends by showing a final icon scene 29 and then a conclusion sequence 30. Other scenes can be used to link the final icon scene 29 to the conclusion scene 30. In the preferred embodiment, the end sequence made up of the final icon scene 29 and the conclusion scene 30 should be substantially similar for each emotion as to give the child the indication that the segment is over.

FIG. 3 is a chart of the primary emotions and the corresponding colors and characters from the preferred embodiment. These characters may be subject to copyrights and trademarks owned by the inventor, but production of these copyrights and trademarks is permitted for purposes relating to the production of copies of this application and, once issued, this patent. Each emotion has been assigned a distinct color and character. In other embodiments, other colors and characters may be used, with the limitation that any element used as a marker for an emotion must be unique to that emotion.

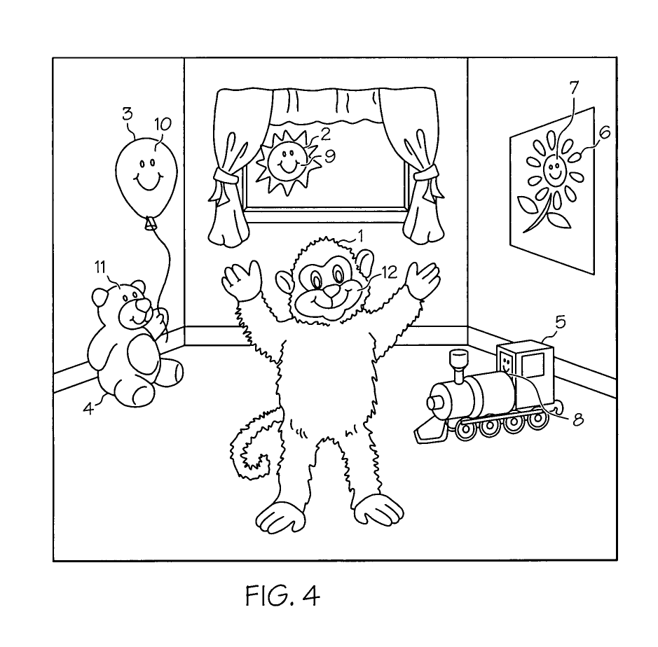

FIG. 4 is an exemplary scene from an introduction sequence 25 from the preferred embodiment. In this scene, the primary emotion is “happy”. The foreground of the scene has a character 1, Happy Lappy. The character's expression 12 is the happy icon 14. In the background is a train 5, a painting of a flower 6, a teddy bear 4, a balloon 3 and a window with a sun 2. The expression 11 in the face of the teddy bear 4 is the happy icon 14. The expression 10 on the balloon 3 is the happy icon 14. The expression 9 on the face of the sun 2 is the happy icon 14. The expression 7 on the face imposed onto the painting of the flower 6 is the happy icon 14. The expression 8 imposed on the front of the train 5 is the happy icon 14. The expression 2 on the face of the character 1 is similar to the happy icon 14. The overall color scheme of the image is yellow, the color identified from FIG. 3 with happy. Even the sky in the window is clear and blue with a sun 2. Note that the scene does not use any written words. Other primary emotions would have an introductory sequence with similar elements, but with coloring, characters, icons and even weather that is identified with that primary emotion.

### PREFERRED EMBODIMENT

The preferred embodiment of the invention envisions a video that is stored on a recordable media. The video is prepared by a professional who selects the emotions, images, markers and sequence for the video. The video is then given to an adult caregiver of a child. The adult then shows the video to the child to teach the child about emotions. Thus the adult can use the skills of the professional when the professional is not present. This video includes any combination of sight and sound that can be stored on some kind of recordable media. The recordable media can be a VHS tape, a DVD, a MPEG or other electronic format. The invention is not limited to any given recordable media. The video is shown on some kind of display. The preferred embodiment envisions a television or computer screen, but the invention is not limited to any particular display. For most recordable media, the video will also require a player. For example, a VHS tape will require a VHS player. A DVD disk will require a DVD player. Other electronic formats, like MPEG, the player is integrated into the display, in this case a computer. The invention is not limited to any particular format of recordable media and thus not limited to any particular kind of display or limited to the presence or absence of a player for that media.

In the preferred embodiment, the invention is envisioned as non-interactive. A child watching the video can learn with interacting with the video. Thus a computer or other input device is not required by the invention. Alternatively, the invention could be part of a larger system were interaction is allowed. In this version of the invention, the video would respond to input from an input device. The invention is not limited by the presence or absence of an input device or other interactive technology.

The invention is envisioned to be able to teach without the presences of another person. This quality makes the invention an automated teaching method. The invention can also be used in conjunction with a lesson plan or course of therapy. The preferred embodiment of the invention envisions a video on a DVD that can be watched by children alone. The invention is an automated teaching method because it will teach with or without the presence or involvement of a second person. Thus the child can learn both without a teacher and without a second child to interact with. The automated nature of the invention is important because it allows a much greater repetition of the lessons in emotions. The limited availability of emotional education service providers creates an artificial limit on the number of times a child can hear lessons on emotions. The automated nature of the invention allows the child to hear the lesson as many times as the child wants without holding the lesson hostage to another person's availability. Furthermore, the automated nature of the invention allows an unlimited number of children to be educated at the same time. As long as every child can see the display, then every child watching can be educated. Furthermore, the automated nature of the invention allows the invention to function without requiring interaction between the child and the invention.

The following examples are for clarity and not meant to limit the scope of the invention in anyway:

The video can use color, type of music, character, type of animal, person miming the emotion or appropriately decorated clown to signify each primary emotion. In the preferred embodiment, color and character are used to mark each emotion.

The scenarios envisioned as the preferred embodiment would consist of a story where emotionally striking things happen. The story could follow a neutral character. Each time something happens that makes the neutral character happy, sad, angry, scared, love or surprised, the neutral character transforms into the emotional character and emotional color that marks that emotion.

Alternatively, the background could change color each time an emotion is shown.

Alternatively, the emotional characters could follow the neutral character around like a Greek chorus. Then each time an emotion is shown, the character for that emotion speaks or steps forward.

Although this invention has been illustrated by reference to specific embodiments, it will be apparent to those skilled in the art that various changes and modification may be made which clearly fall within the scope of the invention. The invention is intended to be protected broadly within the spirit and scope of the appended claims.

What is claimed is:

1. A therapeutic method for improving an ability of a child to recognize and response to primary emotions, said therapeutic method comprising:
providing a video containing a plurality of images containing exaggerated facial expressions which represent the primary emotions;
providing multimedia based markers in the video which correspond each to a particular one of the exaggerated facial expressions that represent the primary emotions in respective ones of the images; and
playing the video to the child.

2. The therapeutic method according to claim 1 wherein the multimedia objective marker for each one of the primary emotions is a separate color, song, character, and icon.

3. The therapeutic method according to claim 1 wherein the exaggerated facial expressions contained in the images representing happiness, sadness, showing love, being angry, being surprised, and being afraid.
